(19) United States
(12) Patent Application Publication
(10) Pub. No.: US 2026/0074091 A1
(43) Pub. Date: Mar. 12, 2026

(54) HIGH VOLTAGE FAULT MANAGED POWER AND FAULT FORCING CABLE

(71) Applicant: Cisco Technology, Inc., San Jose, CA (US)

(72) Inventors: George Allan Zimmerman, Manhattan Beach, CA (US); Chad M. Jones, Doylestown, OH (US); Jason Dewayne Potterf, Austin, TX (US); Joel Richard Goergen, Soulsbyville, CA (US)

(21) Appl. No.: 18/828,591

(22) Filed: Sep. 9, 2024

(51) Int. Cl. H01B 9/00; H01B 17/58

(52) U.S. Cl. CPC H01B 9/006; H01B 17/58

(57) ABSTRACT

Forcing a line to ground fault in a power cable to prevent an occurrence of a line to line fault is provided. Specifically, a cable device includes a conduit jacket and at least one pair of conductors that is contained within and extends along a length of the conduit jacket. The conductors of the at least one pair of conductors within the conduit jacket form a plurality of internal spaces. The at least one pair of conductors is configured to transmit electrical power from a first device to a second device. The cable device further includes a conductive filler inside the conduit jacket occupying spaces within the conduit jacket other than the plurality of internal spaces.

### TECHNICAL FIELD

The present disclosure generally relates to electrical equipment and power cables.

### BACKGROUND

Power cables transmit power and optionally data from power sourcing equipment to powered device(s). Cables may transmit electrical power over pairs of wires. When power cables transmit low power, protection mechanisms may not be necessary. However, high voltage power cables designed to handle higher electrical voltages may pose safety concerns. For example, if a higher voltage power cable is damaged, injuries to users may occur.

### BRIEF DESCRIPTION OF THE DRAWINGS

FIG. 1 is a block diagram illustrating a high power transmission system in which a fault forcing cable is deployed that causes a line to ground fault concurrently with or instead of a line to line fault, according to an example embodiment.

FIG. 2 is a diagram illustrating components of the fault forcing cable of FIG. 1, according to an example embodiment.

FIG. 3 is a diagram illustrating a cross-section view of the fault forcing cable of FIG. 1, according to an example embodiment.

FIG. 4 is a diagram illustrating a system having a connector for trimming excess portions of conductors in the fault forcing cable of FIG. 1, according to an example embodiment.

FIG. 5 is a diagram illustrating additional components of the fault forcing cable of FIG. 1, according to another example embodiment.

FIG. 6 is a flow diagram illustrating a method of causing a line to ground fault in a fault forcing cable to prevent a line to line fault from occurring, according to an example embodiment.

### DETAILED DESCRIPTION

### Overview

Methods, apparatuses, and systems are provided for forcing a line to ground fault in a fault forcing cable to prevent an occurrence of a line to line fault.

In one form, a cable device is provided. The cable device includes a conduit jacket and at least one pair of conductors that is contained within and extends along a length of the conduit jacket, wherein conductors of the at least one pair of conductors within the conduit jacket form a plurality of internal spaces. The at least one pair of conductors is configured to transmit electrical power from a first device to a second device. The cable device further includes a conductive filler inside the conduit jacket occupying spaces within the conduit jacket other than the plurality of internal spaces.

In another form, a system is provided. The system includes a first device and a second device configured to transmit and/or receive an electrical power and a fault forcing cable. The fault forcing cable includes a conduit jacket and at least one pair of conductors that is contained within and extends along a length of the conduit jacket. Conductors of the at least one pair of conductors within the conduit jacket form a plurality of internal spaces. The at least one pair of conductors is configured to transmit electrical power from a first device to a second device. The fault forcing cable further includes a conductive filler inside the conduit jacket occupying spaces within the conduit jacket other than the plurality of internal spaces.

In yet another form, a method is provided. The method includes providing a fault forcing cable having a conduit jacket, at least one pair of conductors that is contained within and extends along a length of the conduit jacket. Conductors of the at least one pair of conductors within the conduit jacket form a plurality of internal spaces. The fault forcing cable includes a conductive filler inside the conduit jacket occupying spaces within the conduit jacket other than the plurality of internal spaces. The method further includes transmitting electrical power, via the fault forcing cable, between a first device and a second device.

### Example Embodiments

With continued technological advances, demand for power increases. Power hungry electrical equipment and/or devices need more power to perform their operations. To accommodate this increasing demand for power, fault managed power (FMP) systems and other higher voltage power systems are deployed. These systems are designed to supply more power e.g., higher voltage power. The term “higher power” or higher voltage” used herein may refer to power exceeding 250 volts (V) such as high voltage alternative current (AC) greater than 250V or high voltage direct current (DC) greater than 250V. In one or more example embodiments, “higher power” or “higher voltage” may refer to equipment or devices operating above the safe thresholds of 60V DC and/or 42.4V AC.

While example embodiments described below use high voltage power and/or FMP, these are just examples. The present disclosure is not limited to these examples. The techniques and devices presented herein may apply to other power system such as Power over Ethernet (PoE) systems, Power over Fiber (PoF) systems, etc., depending on a particular deployment and use case scenario.

The term “Fault Managed Power” (FMP) as used herein refers to power operation delivered on one or more wires or wire pairs. FMP may use pulse power or other types of power. That is, FMP may be accomplished in a non-pulsing manner. FMP may involve fault sensing with or without the use of pulse power. As described below, power and data may be transmitted together (in-band) on at least one wire pair. FMP also includes fault detection (e.g., fault detection (safety testing) at initialization and between high voltage pulses) and pulse synchronization between power sourcing equipment and a powered device. The power may be transmitted with communications (e.g., bi-directional communications) or without communications.

The term “pulse power” (also referred to as “pulsed power”) as used herein refers to power that is delivered in a sequence of pulses. High voltage pulse power (e.g., >56VDC, >60VDC, >300VDC, ˜108VDC, ˜380VDC) may be transmitted from power sourcing equipment to a powered device for use in powering the powered device. Pulse power transmission may be through cables, transmission lines, bus bars, backplanes, PCBs (Printed Circuit Boards), and power distribution systems, for example. It is to be understood that the power and voltage levels described herein are only examples and other levels may be used.

In one or more embodiments, FMP may comprise pulse power transmitted in multiple phases in a multi-phase pulse power system with pulses offset from one another between wires or wire pairs to provide continuous power. One or more example embodiments may use multi-phase pulse power to achieve less loss, with continuous uninterrupted power with overlapping phase pulses.

FMP may be converted into PoE and used to power electrical equipment or devices. The power system may be configured for PoF, advanced power over data, FMP, or any other power over communications system in accordance with current or future standards, which may be used to pass electrical power along with data to allow a single cable to provide both data connectivity and electrical power to electrical devices and equipment.

When transmitting higher voltage FMP, it is desirable to include various safety mechanisms to protect environment and users. Line to line faults may be particularly dangerous because of short circuiting. As such, the techniques presented herein prevent a line to line fault by causing a line to ground fault. That is, a fault forcing cable is provided in which the line to line fault is prevented and does not occur without a concurrent line to ground fault (a shield fault). In other words, when the fault forcing cable is damaged e.g., punctured by a conductive object, the line to line fault cannot occur without the shield fault. Meanwhile, signal characteristics of the signal transmitted in the fault forcing cable are maintained end-to-end i.e., impedance of transmission is maintained.

While one or more example embodiments describe a twisted pair of wires or cables, this is just an example. The present disclosure is not limited to these examples. The techniques and devices presented herein may apply to any multi-conductor cable in which the conductors are in a specific geometry with internal spaces being formed therebetween. For example, the techniques presented herein may apply to twisted pair of wires, parallel pair of wires, coaxial cables, and/or twin axial cable, where the spaces between the insulated conductors are filled with a conductive powder.

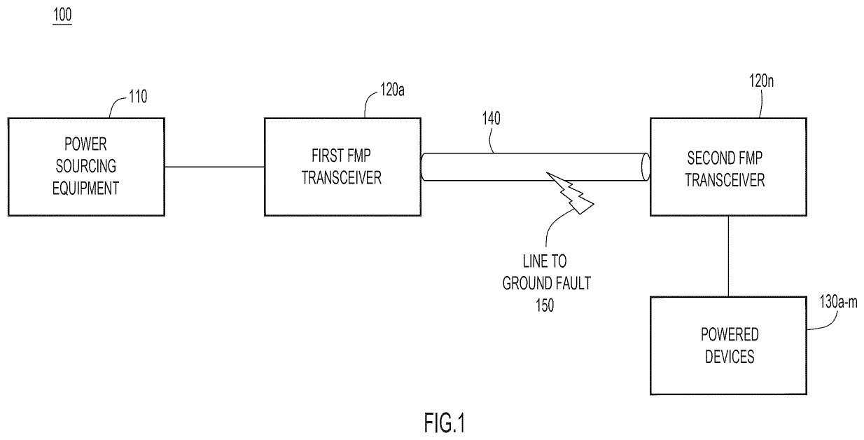

Reference is now made to FIG. 1. FIG. 1 is a block diagram illustrating a high power transmission system 100 in which a fault forcing cable is deployed that causes a line to ground fault concurrently with or instead of a line to line fault, according to an example embodiment. The high power transmission system 100 includes a power sourcing equipment 110, FMP transceivers 120a-n including a first FMP transceiver 120a and a second FMP transceiver 120n, powered devices 130a-m, and a fault forcing cable 140.

The notations 1, 2, 3, . . . n; a, b, c, . . . n; “a-n”, “a-m”, “a-f”, “a-g”, “a-k”, “a-c”, and the like illustrate that the number of elements can vary depending on a particular implementation and is not limited to the number of elements being depicted or described. Additionally, the same numeric reference denotes an analogous component. As noted above, this is only an example of various components, and the number and types of components, functions, etc. may vary based on a particular deployment and use case scenario. Moreover, this is just one example and the high power transmission system 100 may include other entities or nodes depending on a particular deployment and/or use case scenario. Example embodiments described herein provide delivery of power to meet power needs in commercial and residential environments.

The power sourcing equipment 110 includes one or more power sources that supply higher voltage power. The power sourcing equipment 110 may provide utility AC power, DC power, FMP, and/or power from an alternative energy source such as a solar power system and/or a wind power system (e.g., >300VDC or other higher voltage).

In one or more example embodiments, components of the power sourcing equipment 110 are power source(s), a power converter, and an FMP block. The power sources may be a utility power source and any other type of usable power sources. The input power may be converted at the power converter e.g., AC power to DC power and/or DC power to AC power. The converted power is transmitted to the FMP block. The FMP block includes an FMP transmitter, a power and data interface, and an FMP receiver. Specifically, power received at the FMP transmitter is converted to FMP and delivered to the power and data interface for transmittal to the FMP transceivers 120a-n. Power received at the power and data interface (i.e., a bi-directional power connector) may be provided to the FMP receiver and converted to DC power for use by other systems.

FMP transceivers 120a-n are configured to transmit or receive higher voltage power from the power sourcing equipment 110. The received higher voltage power may be combined with data and converted to FMP and transmitted to another FMP transceiver and/or powered devices 130a-m. Specifically, each FMP transceiver may include an FMP transmitter, power and data interface, and an FMP receiver. Power and data are received at the FMP receiver and delivered to the FMP transmitter for transmission to another FMP transceiver and/or powered devices 130a-m.

In the high power transmission system 100, the first FMP transceiver 120a receives power from the power sourcing equipment 110 and provides it to the second FMP transceiver 120n via the fault forcing cable 140. The second FMP transceiver 120n receives the FMP power (optionally converts it to AC power and/or DC power) and provides it to the powered devices 130a-m.

The powered devices 130a-m may be user equipment and/or network devices, or any other electrical appliances. By way of an example, powered devices 130a-m may include a power receiving interface, a data receiving interface, a controller or a processor, a memory with control logic, graphical processing unit (GPU), a display, etc.

The fault forcing cable 140 is configured to transmit electrical power (and optionally data) between one or more entities of the high power transmission system 100. While in the high power transmission system 100, the fault forcing cable 140 is between the first FMP transceiver 120a and the second FMP transceiver 120n, the disclosure is not limited thereto. The fault forcing cable 140 may be deployed between one or more other entities of the high power transmission system 100 e.g., the power sourcing equipment 110 and the first FMP transceiver 120a. In one or more example embodiments, the fault forcing cable 140 is configured to transmit higher voltage power e.g., higher voltage FMP power.

That fault forcing cable 140 is a connector and/or a current loop. The fault forcing cable 140 may transmit electrical power of approximately >300V e.g., higher voltage FMP (not exceeding the 450V peak restriction. The disclosure is not limited thereto, and the fault forcing cable 140 may transmit other power levels.

The fault forcing cable 140 includes twisted pair of wires or conductors. The fault forcing cable 140 is designed to prevent a line to line fault by providing a shield fault (a ground fault) concurrently (at the same time). A line to line fault may involve lines touching causing a short circuit. Another example of a line to line fault may involve line to line arc fault. These types of faults are safety hazards and should be avoided. As such, the fault forcing cable 140 is configured to cause a line to ground fault before or concurrently with a line to line fault.

Line to line faults may occur because of fault forcing cable 140 degradation i.e., degradation in line conductor insulation. Also, the fault forcing cable 140 may be punctured with a conductive object also causing a short circuit (line to line fault). However, in these instances, the fault forcing cable 140 forces a line to ground fault 150, while impedance of transmission is maintained, as detailed below.

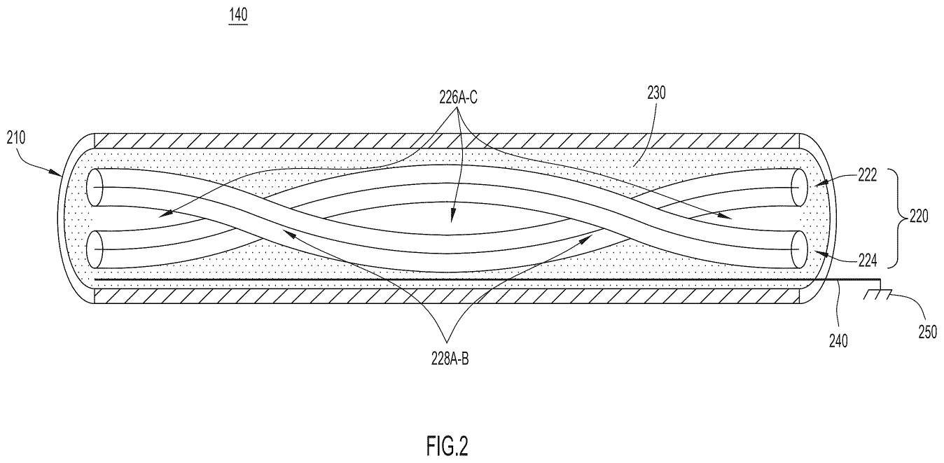

With continued reference to FIG. 1, reference is now made to FIG. 2. FIG. 2 is a diagram illustrating components of the fault forcing cable 140 of FIG. 1, according to an example embodiment. The fault forcing cable 140 may include a conduit jacket 210, a pair of conductors 220 that include a first wire 222 and a second wire 224, a conductive filler 230, and a drain wire 240.

While example embodiments describe a pair of conductors 220, this is just an example and the disclosure is not limited thereto. There may be multiple pairs of conductors. Also, there may be three or more conductors twisted together. The number of conductors and/or twisted pairs of conductors depends on a particular deployment and use case scenario.

The conduit jacket 210 is a sleeve, a cylindrical layer, or a housing for the pair of conductors 220. The conduit jacket 210 is an outer layer of the fault forcing cable 140. The conduit jacket 210 is configured to protect the pair of conductors from external environmental factors e.g., wind, water, etc. The conduit jacket 210 is a non-conductive layer. For example, the conduit jacket 210 may be made of plastic, rubber, and/or polyvinyl chloride (PVC).

The pair of conductors 220 transmits electrical power and are contained within the conduit jacket 210. The pair of conductors 220 extends along the length of the conduit jacket 210. The pair of conductors 220 is wires made of conductive material. The pair of conductors 220 may be copper wires, aluminum wires, or wires made of various other metals or a combination thereof. The pair of conductors 220 may further transmit data.

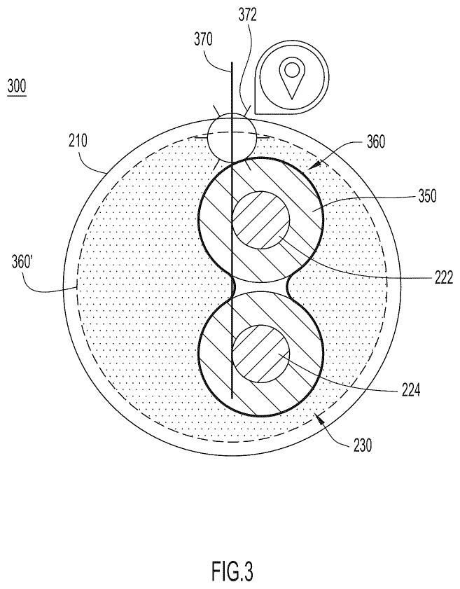

Each conductor may be a single solid conductor or a plurality of stranded conductors that conduct electrical power. A diameter of each conductor may depend on amount of power that to be transmitted. For example, the pair of conductors 220 may transmit power at approximately >=350V. That is, the first wire 222 may conduct approximately >=+175V and the second wire 224 may conduct approximately >=−175V, but this is just an example. Each conductor is individually insulated, an example of which is described in FIG. 3.

Conductors of the pair of conductors 220 are twisted together within the conduit jacket 210 such that internal spaces 226a-c are formed. The geometry of the twisted pair is not limited to the one depicted in FIG. 2. The internal spaces 226a-c may be oval or circular and depend on a particular deployment and/or use case scenario. Conductors of the pair of conductors 220 are twisted together and may be bonded at connection points 228a-b. In one example embodiment, there may be several sets of conductor pairs that are braided together with internal spaces 226a-c formed therebetween.

A conductive filler 230 is disposed inside the conduit jacket 210. The conductive filler 230 has conductive material such that if the fault forcing cable 140 is punctured, the conductive filler 230 will cause a line to ground fault before or concurrently with a potential line to the line fault. That is, in an event the fault forcing cable 140 is punctured with a damaging object, the damaging object first contacts the conductive filler 230, thus forcing a line to ground fault. The conductive filler 230 causes the ground fault upon a degradation of the fault forcing cable 140 e.g., upon a degradation of the conduit jacket 210 and more specifically, an individual insulation of the pair of conductors 220 e.g., when the fault forcing cable 140 is punctured with a sharp metal object.

The conductive filler 230 may be powder, a powder mixture, and/or dielectric material. The powder may be colored talcum powder i.e., brightly colored for easy detection. The powder mixture may include approximately 80% of a conductive material and approximately 20% of a nonconductive material. Some non-limiting examples of conductive powder material include a metal powder (e.g., steel, nickel, copper, aluminum). Some non-limiting examples of the nonconductive powder material include glass, ceramic and/or plastic. In one example embodiment, the conductive filler 230 may be conductive foam.

In one example embodiment, the conductive filler 230 may be a colored powder or a colored foam. That is, the conductive filler 230 is brightly colored for high visibility. The colored powder may be used to detect a fault in the fault forcing cable 140. That is, the colored powder may leak out of the conduit jacket 210 at a point of damage, thus indicating the damaged portion. When the fault forcing cable 140 is cut or punctured, the damaged portion is identified based on the colored powder leaking or falling out of the fault forcing cable 140. Since the fault forcing cable 140 bleeds at the point of the cut, the damage is easily detected based on the bright color of the conductive filler 230.

The conductive filler 230 fills external areas formed by the twisted wire pairs with internal areas not having any of the conductive filler 230. That is, the conductive filler 230 inside the conduit jacket 210 occupy spaces within the conduit jacket 210 other than the internal spaces 226a-c. The pair of conductors 220 are bonded together at connection points 226a-c to prevent the conductive filler 230 from entering inside the internal spaces 226a-c. This is particularly useful to maintain impedance between the first wire 222 and the second wire 224. That is, the conductive filler 230 is prevented from seeping into the internal spaces 226a-c or wedging between the first wire 222 and the second wire 224, thus interfering with impedance of the transmission. That is, characteristics of the signal are maintained from end-to-end of the fault forcing cable by preventing the conductive filler 230 from entering the internal spaces 226a-c. As such, the first wire 222 and the second wire 224 are bonded at the connection points 226a-c to exclude the conductive filler 230 from entering the internal spaces 226a-c.

Additionally, the drain wire 240 may be included to provide a shield 250. The drain wire 240 extends along the length of the conduit jacket 210. The drain wire 240 helps to further ensure a ground to line fault using the conductive filler 230 and prevent a line to line fault from occurring in the fault forcing cable 140.

With continued reference to FIGS. 1 and 2, FIG. 3 is a diagram illustrating a cross-section view 300 of the fault forcing cable 140, according to an example embodiment. The fault forcing cable 140 includes the conduit jacket 210, the first wire 222, the second wire 224, and the conductive filler 230 of FIG. 2. The fault forcing cable 140 further includes an individual insulation layer 350 and a conductive insulation layer 360 or an external insulation layer 360′.

The individual insulation layer 350 surrounds a respective conductor of the pair of conductors 220. The individual insulation layer 350 extends along the length of the respective conductor. The individual insulation layer 350 is configured to shield the respective conductor. The individual insulation layer 350 may be made of a polymer, plastic, or rubber. The diameter of the individual insulation layer 350 is based on the thickness of the respective conductor i.e., based on voltage that the conductor is designed to conduct. The individual insulation layer 350 may provide thermal insulation and reduce the potential of the line to line fault. In some examples, the individual insulation layer 350 includes polyethylene, rubber, and/or High Performance Thermoplastic Elastomer (HPTE).

The conductive insulation layer 360 is disposed between the individual insulation layer 350 and the conduit jacket 210. The conductive insulation layer 360 may be made of metal material(s). The conductive insulation layer 360 may be foil over wires or a conductive skin over wires. The conductive insulation layer 360 maybe on the inside or on the outside with respect to the conductive filler 230. In one example embodiment, the conductive insulation layer 360 may extend adjacent to the conduit jacket 210, shown as an external insulation layer 360′. The external insulation layer 360′ may be foil or a foil wrap. In another example embodiment, the conductive insulation layer 360 surrounds both individual insulation layers that hold the respective conductor therein. That is, the conductive insulation layer 360 surrounds the first wire 222 and the second wire 224 but outside of their respective individual insulation layer (the individual insulation layer 350). When the fault forcing cable is cut with a sharp object 370, for example, the conductive filler 230 forces a ground fault, shown at 372.

With continued reference to FIGS. 1-3, FIG. 4 is a diagram illustrating a system 400 having a connector for trimming excess portions of conductors in the fault forcing cable 140 of FIG. 1, according to an example embodiment. The system 400 includes a connector 410 that is attached to a termination point of the fault forcing cable 140 for trimming excess portions 420 of the first wire 222 and the second wire 224 in the pair of conductors 220 of FIG. 2 without conductive powder 430 bleeding out of the fault forcing cable 140.

The connector 410 attaches at a termination point (at an end) of the fault forcing cable 140. That is, the termination point of the fault forcing cable 140 is covered with the connector 410. The connector 410 prevents the conductive filler 230 (i.e., the conductive powder 430) from bleeding out of the fault forcing cable 140. Specifically, at an end portion of the fault forcing cable 140 (the termination point), the conduit jacket 210 is stripped, shown at 440. The connector 410 covers the end portion of the conduit jacket 210 and extends to the stripped portion of the fault forcing cable 140.

The connector 410 excludes the conductive powder 430 and prevents the conductive powder 430 from spilling out of the fault forcing cable 140 at the end portion (termination point). That is, the connector 410 seals the end of the fault forcing cable 140, thus ensuring that the conductive powder 430 does not spill out of the fault forcing cable 140. As such, when excess portions 420 of the first wire 222 and second wire 224 are trimmed, shown at 450, the conductive powder 430 does not bleed out of the fault forcing cable 140. The conductive powder 430 may be a powder mixture having approximately 80% of a conductive material and approximately 20% of a nonconductive material.

While one connector, i.e., the connector 410, is shown, this is just an example. Both ends of the fault forcing cable 140 (at both termination points) may include the connector 410. That is, the connector 410 is attached to any termination point of the fault forcing cable 140 such that the conductive powder 430 does not bleed when trimming excess portions 420 of the pair of conductors 220. The connector 410 excludes the conductive powder 430 and is pushed over the conduit jacket 210 to seal the fault forcing cable 140. When the connector 410 is securely attached to the end of the fault forcing cable 140, excess portions 420 of the pair of conductors 220 are cut.

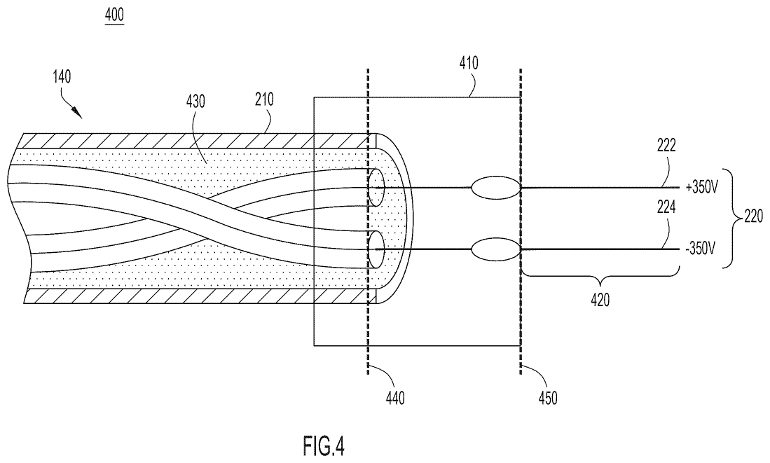

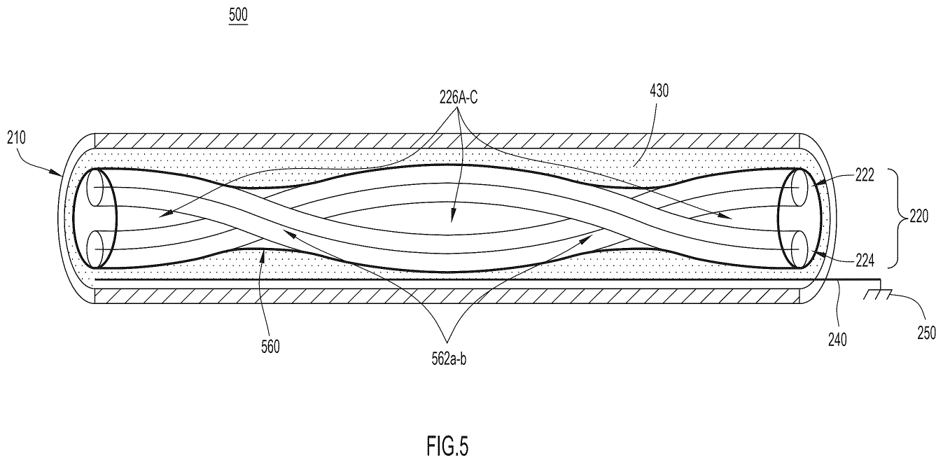

With continued reference to FIGS. 1-4, FIG. 5 is a diagram illustrating additional components 500 of the fault forcing cable 140 of FIG. 1, according to another example embodiment. The fault forcing cable 140 includes the conduit jacket 210 of FIGS. 2-4, the pair of conductors 220 including first wire 222 and the second wire 224 of FIGS. 2-4, the conductive powder 430 of FIG. 4, the drain wire 240 of FIG. 2, and the shield 250 of FIG. 2. Examples of these components were described above. The additional components 500 of the fault forcing cable 140 include a conductive insulation layer 360 of FIG. 3 (e.g., a foil shield) and a wrapping layer 560 that blocks the conductive powder 430 of FIG. 4 from entering internal spaces 226a-c.

The conductive insulation layer 360 may be a foil wrap that extends along the length of the conduit jacket 210 and optionally, abuts the conduit jacket 210. The conductive powder 430 occupies spaces inside of the conductive insulation layer 360. That is, the conductive powder 430 is disposed between the conductive insulation layer 360 and the wrapping layer 560. As noted above, the conductive powder 430 may be a powder mixture that has approximately 80% of a conductive material and approximately 20% of a nonconductive material.

The wrapping layer 560 surrounds the pair of conductors 220 and is configured to seal each twist (e.g., the twists 562a-b) of the pair of conductors 220 to block the conductive powder 430 from entering the internal spaces 226a-c. The conductive powder 430 remains outside of the wrapping layer 560. That is, the conductive powder 430 occupies spaces outside of the wrapping layer 560.

The wrapping layer 560 extends along the length of the pair of conductors 220. The wrapping layer 560 may be a shrink wrap or a wrap that seals each twist in the pair of conductors 220. In one example embodiment, the wrapping layer 560 maybe a conductive skin that fits tightly over the pair of conductors 220. In yet another example embodiment, the wrapping layer 560 may be a shrink wrap secured over the twists 562a-b in the pair of conductors 220. In yet another example embodiment, the wrapping layer 560 may be a braid over the pair of conductors 220.

The wrapping layer 560 ensures that the conductive powder 430 does not wedge into the internal spaces 226a-c, which may interfere with impedance of the transmission signal. That is, while power lines or power cables may not need to maintain signal characteristics, the fault forcing cable 140 should ensure impedance of the transmission and maintain signal characteristics from one end to the other end of the fault forcing cable 140. If the conductive powder 430 wedges into the internal spaces 226a-c, signal impedance may be distorted. As such, the wrapping layer 560 ensures that the conductive powder 430 remains outside of the twisted pair of conductor pairs. In one example embodiment, the pair of conductors 220 may be bonded at the twists 562a-b to exclude the conductive powder 430 from the internal spaces 226a-c.

The techniques presented herein mitigate a line to line fault, which may cause safety hazards, by forcing a ground fault where one would not occur otherwise. The ground fault is forced by a conductive filler that occupies spaces within a conduit jacket of the cable other than internal spaces. The conductive filler may be a powder mixture having approximately 80% of a conductive material and approximately 20% of a nonconductive material. Internal spaces are formed by one or more pair of conductors being twisted together, or by other techniques depending on a particular multi-conductor geometry. For example, a wrapping layer may be used to seal the conductive material within internal spaces when a parallel pair of cables are being used. Internal spaces are maintained free from the conductive filler to maintain impedance of transmission i.e., the signal being transmitted. In other words, there is no conductive material in areas between the twisted pairs of wires.

Additionally, the techniques presented herein provide a connector that fits, slides, or attached onto a termination end of the fault forcing cable to avoid conductive filler from falling out of the cable when excess portions of the conductor may be cut. Moreover, the techniques presented herein bond the twists in the pair of conductors and/or use a shrinking wrap to seal the twists in order to prevent the conductive filler from wedging into the internal spaces formed by the twisted pair of conductors.

Also, the techniques presented herein provide for detecting punctured/damaged portions of the fault forcing cable using a colored conductive filler. That is, if a cable is punctured, the colored conductive filler spills outside of the cable, the color is easy to detect and thus indicates the damaged portion of the cable.

The technique described are applicable to transmission over two or more conductors within a jacket where internal spaces are formed. This may include twisted pairs of conductors, coaxial cable elements, parallel pairs of conductors, and/or twin axial cabling elements. That is, the techniques presented herein apply to various multi-conductor geometries.

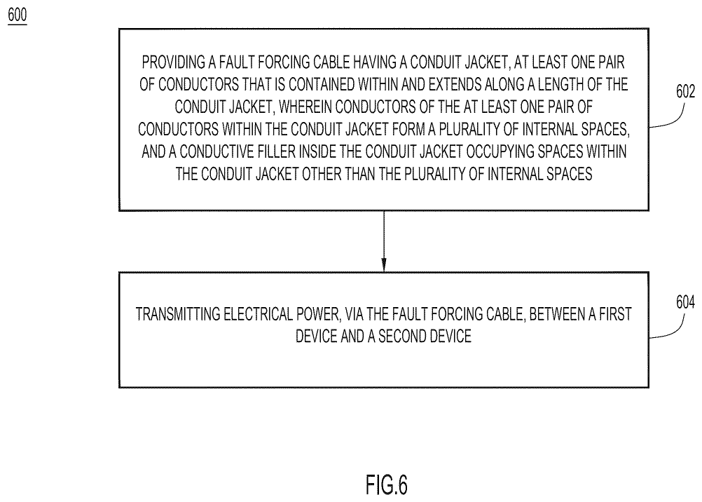

Reference is now made to FIG. 6. FIG. 6 is a flow diagram illustrating a method 600 of causing a line to ground fault in a fault forcing cable to prevent a line to line fault from occurring, according to an example embodiment.

At 602, the method 600 involves providing a fault forcing cable having a conduit jacket, at least one pair of conductors that is contained within and extends along a length of the conduit jacket. The conductors of the at least one pair of conductors within the conduit jacket form a plurality of internal spaces. The fault forcing cable further includes a conductive filler inside the conduit jacket occupying spaces within the conduit jacket other than the plurality of internal spaces.

At 604, the method 600 involves transmitting electrical power, via the fault forcing cable, between a first device and a second device.

In one form, the method 600 may further involve causing a ground fault via the conductive filler, upon a degradation of the conduit jacket.

In another form, the method 600 may further involve detecting a fault in the fault forcing cable based on the conductive filler extending outside of the conduit jacket upon a degradation of the conduit jacket.

According to one or more example embodiment, the operation 602 of providing the fault forcing cable may further involve providing the fault forcing cable in which the conductors of the at least one pair of conductors are bonded together at a plurality of connection points to exclude the conductive filler from the plurality of internal spaces.

In one instance, the operation 602 of providing the fault forcing cable may further involve providing the fault forcing cable in which each conductor of the at least one pair of conductors is surrounded by an individual insulation layer and in which a conductive insulation layer is disposed between the individual insulation layer and the conduit jacket.

In another example embodiment, a cable device is provided. The cable device includes a conduit jacket and at least one pair of conductors that is contained within and extends along a length of the conduit jacket. Conductors of the at least one pair of conductors within the conduit jacket form a plurality of internal spaces. The at least one pair of conductors is configured to transmit electrical power from a first device to a second device. The cable device further includes a conductive filler inside the conduit jacket occupying spaces within the conduit jacket other than the plurality of internal spaces.

In one form, the conductors of the at least one pair of conductors may be bonded together at a plurality of connection points to exclude the conductive filler from the plurality of internal spaces.

In one instance, the conductive filler may be a conductive powder that causes a ground fault upon a degradation of the conduit jacket.

In another instance, the conductive powder may be colored powder.

In yet another instance, the conductive powder may be a powder mixture including approximately 80% of a conductive material and approximately 20% of a nonconductive material.

According to one or more example embodiments, the cable device may include an individual insulation layer surrounding each conductor of the at least one pair of conductors and a conductive insulation layer between the individual insulation layer and the conduit jacket.

In one form, the conductive insulation layer may be disposed between the conductive filler and the conduit jacket.

In another form, the conductive insulation layer may surround the at least one pair of conductors. The conductive filler may be disposed between the conductive insulation layer and the conduit jacket.

In yet another form, the conductive insulation layer may be a foil wrap that surrounds the at least one pair of conductors.

According to one or more example embodiments, the conductors of the at least one pair of conductors may be twisted together. The cable device may further include a wrapping layer may surround the at least one pair of conductors and may be configured to seal each twist of the at least one pair of conductors to block the conductive filler from the plurality of internal spaces. The conductive filler may be outside of the wrapping layer.

In yet another example embodiment, a system is provided. The system includes a first device and a second device configured to transmit and/or receive an electrical power. The system further includes a fault forcing cable. The fault forcing cable includes a conduit jacket and at least one pair of conductors that is contained within and extends along a length of the conduit jacket. The conductors of the at least one pair of conductors within the conduit jacket form a plurality of internal spaces. The at least one pair of conductors is configured to transmit electrical power from a first device to a second device. The fault forcing cable further includes a conductive filler inside the conduit jacket occupying spaces within the conduit jacket other than the plurality of internal spaces.

In one form, the system may further include a connector configured to attach to a termination point of the fault forcing cable to seal the conductive filler inside the fault forcing cable.

In another form, the first device and the second device may be power transceivers configured to transmit and receive power via the at least one pair of conductors.

In yet another form, the at least one pair of conductors may be configured to transmit the electrical power above 60 volts.

According to one or more example embodiments, the conductors of the at least one pair of conductors may be bonded together at a plurality of connection points to exclude the conductive filler from the plurality of internal spaces.

In one instance, the conductive filler may be a conductive powder that causes a ground fault upon a degradation of the conduit jacket.

In another instance, the conductive powder may be a colored powder.

In yet another example embodiment, an arrangement may be provided that includes the devices and operations explained above with reference to FIGS. 1-6.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, the storage and/or memory elements(s) can store data, software, code, instructions (e.g., processor instructions), logic, parameters, combinations thereof, and/or the like used for operations described herein. This includes the storage and/or memory elements(s) being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm. wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A cable device comprising:
a conduit jacket;
at least one pair of conductors that is contained within and extends along a length of the conduit jacket, wherein conductors of the at least one pair of conductors within the conduit jacket form a plurality of internal spaces, wherein the at least one pair of conductors is configured to transmit electrical power from a first device to a second device; and
a conductive filler inside the conduit jacket occupying spaces within the conduit jacket other than the plurality of internal spaces.

2. The cable device of claim 1, wherein the conductors of the at least one pair of conductors are bonded together at a plurality of connection points to exclude the conductive filler from the plurality of internal spaces.

3. The cable device of claim 2, wherein the conductive filler is a conductive powder that causes a ground fault upon a degradation of the conduit jacket.

4. The cable device of claim 3, wherein the conductive powder is a colored powder.

5. The cable device of claim 3, wherein the conductive powder is a powder mixture including approximately 80% of a conductive material and approximately 20% of a nonconductive material.

6. The cable device of claim 2, further comprising:
an individual insulation layer surrounding each conductor of the at least one pair of conductors; and
a conductive insulation layer between the individual insulation layer and the conduit jacket.

7. The cable device of claim 6, wherein the conductive insulation layer is disposed between the conductive filler and the conduit jacket.

8. The cable device of claim 6, wherein the conductive insulation layer surrounds the at least one pair of conductors, and wherein the conductive filler is disposed between the conductive insulation layer and the conduit jacket.

9. The cable device of claim 6, wherein the conductive insulation layer is a foil wrap that surrounds the at least one pair of conductors.

10. The cable device of claim 1, wherein the conductors of the at least one pair of conductors are twisted together, and further comprising:
a wrapping layer that surrounds the at least one pair of conductors and is configured to seal each twist of the at least one pair of conductors to block the conductive filler from the plurality of internal spaces, wherein the conductive filler is outside of the wrapping layer.

11. A system comprising:
a first device and a second device configured to transmit and/or receive an electrical power; and
a fault forcing cable including:
a conduit jacket;
at least one pair of conductors that is contained within and extends along a length of the conduit jacket, wherein conductors of the at least one pair of conductors within the conduit jacket form a plurality of internal spaces, wherein the at least one pair of conductors is configured to transmit electrical power from a first device to a second device; and
a conductive filler inside the conduit jacket occupying spaces within the conduit jacket other than the plurality of internal spaces.

12. The system of claim 11, further comprising:
a connector configured to attach to a termination point of the fault forcing cable to seal the conductive filler inside the fault forcing cable.

13. The system of claim 11, wherein the first device and the second device are power transceivers configured to transmit and receive power via the at least one pair of conductors.

14. The system of claim 11, wherein the at least one pair of conductors is configured to transmit the electrical power above 60 volts.

15. The system of claim 11, wherein the conductors of the at least one pair of conductors are bonded together at a plurality of connection points to exclude the conductive filler from the plurality of internal spaces.

16. The system of claim 11, wherein the conductive filler is a conductive powder that causes a ground fault upon a degradation of the conduit jacket.

17. The system of claim 16, wherein the conductive powder is a colored powder.

18. A method comprising:
providing a fault forcing cable having a conduit jacket, at least one pair of conductors that is contained within and extends along a length of the conduit jacket, wherein conductors of the at least one pair of conductors within the conduit jacket form a plurality of internal spaces, and a conductive filler inside the conduit jacket occupying spaces within the conduit jacket other than the plurality of internal spaces; and
transmitting electrical power, via the fault forcing cable, between a first device and a second device.

19. The method of claim 18, further comprising:
causing a ground fault via the conductive filler, upon a degradation of the conduit jacket.

20. The method of claim 18, further comprising:
detecting a fault in the fault forcing cable based on the conductive filler extending outside of the conduit jacket upon a degradation of the conduit jacket.
